(19) United States
(12) Patent Application Publication
(10) Pub. No.: US 2005/0083403 A1
(43) Pub. Date: Apr. 21, 2005

(54) Vehicle mounted display apparatus and method

(76) Inventors: Kenneth J. Flores, Las Vegas, NV (US); Jodi L. Flores, Las Vegas, NV (US)

Correspondence Address: WEISS & MOY PC, 4204 NORTH BROWN AVENUE, SCOTTSDALE, AZ, 85251, US

(21) Appl. No.: 10/688,760

(22) Filed: Oct. 20, 2003

(51) Int. Cl. H04N 7/18

(52) U.S. Cl. 348/61

(57) ABSTRACT

A method and apparatus for generating and displaying sequences of images on a vehicle-mounted display. One embodiment uses rotated display surfaces mounted on a vehicle rooftop. Another embodiment uses multi-pixel screens mounted or connected to generally horizontal or generally vertical surfaces of the vehicle adapted to display generated sequences of images. The multi-pixel screens are easily added or removed from the vehicle-mounted display and are individually capable of displaying separate sequences of images.

### FIELD OF THE INVENTION

This invention relates generally to vehicle-mounted displays and methods therefor and, more particularly, to a vehicle-mounted display apparatus and method of displaying a sequence of images from a vehicle.

### DESCRIPTION OF RELATED ART

Vehicle advertising has become an increasingly popular form of advertisement. Typically, such advertising essentially functions as a mobile billboard mounted on the bed of a truck or roof of a car. Such displays can also be towed on a trailer behind a vehicle and are often illuminated with exterior lights for nighttime viewing by pedestrians and occupants of other vehicles.

However, current methods of vehicle advertising display a single image on each display surface and lack the ability to hold a viewer's attention beyond an initial viewing. For example, a person sitting in traffic near such a display will likely read the advertisement only once, although the display may remain in view for a considerable amount of time.

Another drawback to current methods of mobile advertisement is the difficulty in changing the displayed image. The time and effort required to change images can make frequent changes economically impractical.

In addition, current systems do not offer the flexibility of easily being able to reconfigure the arrangement of images displayed. For example, a three-sided rooftop sign cannot easily be adapted to show a fourth image.

The present invention satisfies these needs, and provides other, related, advantages.

### SUMMARY OF THE INVENTION

It is an object of the present invention to provide a method and apparatus for displaying sequences of images on a vehicle-mounted display.

It is a further object of the present invention to provide an apparatus and method for displaying sequences of images on a vehicle-mounted display by rotating display surfaces relative to a generally horizontal vehicle surface.

It is a further object of the present invention to provide an apparatus and method for displaying sequences of images on a vehicle-mounted display using multiple multi-pixel display surfaces.

The foregoing and other objects, features, and advantages of the invention will be apparent from the following, more particular, description of embodiments of the invention, as illustrated in the accompanying drawings.

### BRIEF DESCRIPTION OF THE PREFERRED EMBODIMENTS

In accordance with one embodiment of the present invention, a vehicle display apparatus is disclosed. The vehicle display apparatus comprises a vehicle, at least one display surface coupled to the vehicle and adapted for displaying at least one sequence of visual images, and means coupled to the vehicle for generating the at lest one sequence of visual images.

In accordance with another embodiment of the present invention, a method is disclosed for displaying at least one sequence of visual images from a vehicle. The method comprises the steps of providing a vehicle, coupling at least one display surface to an exterior surface of a vehicle, and displaying at least one sequence of visual images on the at least one display surface.

In accordance with another embodiment of the present invention, a method is disclosed of displaying images from a vehicle. This method comprises the steps of providing a vehicle and attaching a housing on the vehicle rooftop. The housing is adapted to support a variable number of television screens. This method further comprises mounting a plurality of television screens on the housing so that from any direction at least one of the screens is visible by pedestrian observers, generating a plurality of video signals, and transmitting each of the plurality of video signals to a corresponding one of the plurality of television screens.

### BRIEF DESCRIPTION OF THE DRAWINGS

FIG. 1 is a perspective view depicting a vehicle display apparatus according to one embodiment of the present invention.

FIG. 2 is a cross-sectional view of the vehicle display apparatus of FIG. 1.

FIG. 3 is a top view of a vehicle display apparatus similar to the display apparatus of FIG. 1 with an arrow showing a rotational motion of the vehicle display housing.

FIG. 4 is a perspective view depicting a vehicle display apparatus with plasma screens on a vehicle rooftop according to an alternate embodiment of the present invention.

FIG. 5 is a top view of the vehicle display apparatus of FIG. 4 showing a video signal generator and a quick-disconnect wiring connector which would preferably located within the vehicle.

FIG. 6 is side elevational view of the vehicle display apparatus of FIG. 4.

FIG. 7 is a perspective view depicting a vehicle display apparatus with plasma screens on the side of a vehicle connected to a video signal generator according to still another embodiment of the present invention.

### DESCRIPTION OF EMBODIMENTS OF THE INVENTION

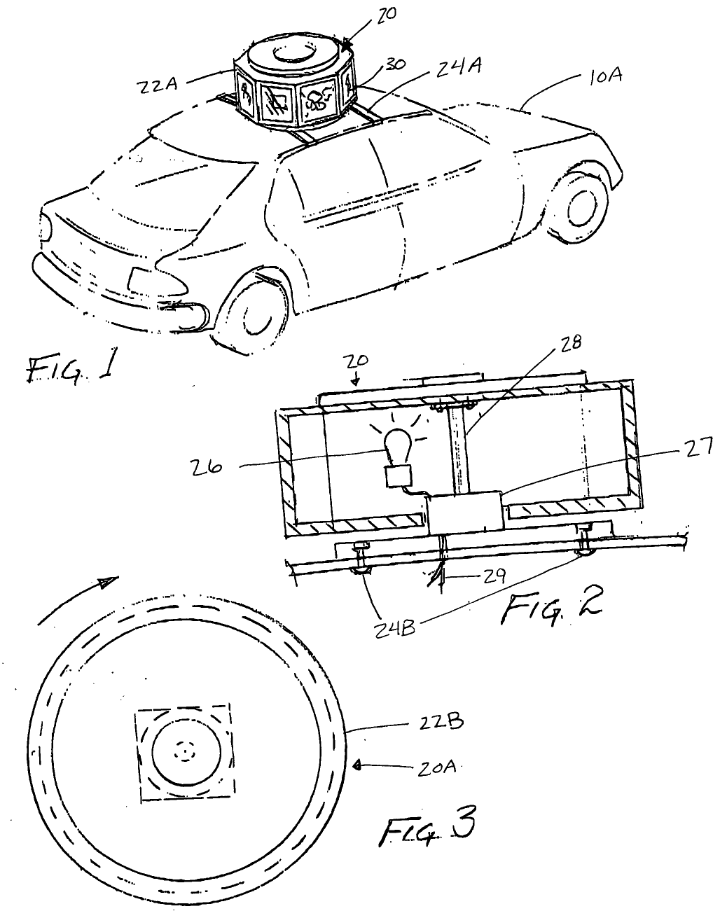

With reference now to the figures, and in particular to FIGS. 1-3, an embodiment of a vehicle mounted variable display apparatus in accordance with the present invention is shown. Referring to FIG. 1, display housing 20 shown mounted on the roof of a vehicle 10A provides a sequence of images to pedestrian viewers and occupants of nearby vehicles by rotating display surfaces 22A relative to vehicle 10A. Preferably, display surfaces 22A contain images 30 such as for advertising products to nearby observers. As the rotation of the display housing 20 brings each display surface 22A first into and then out of an observer's view, the images 30 form a repeating sequence of images for the observer.

Display housing 20, for example, is fastened to vehicle 10A with straps 24A (see FIG. 1) that preferably extend to the windows of the vehicle 10A. Straps 24A preferably enter into the vehicle 10A and fasten within the interior of vehicle 10A. Alternatively, the straps 24A may terminate in hooks to fasten to the edge of the roof of the vehicle 10A. Preferably, straps 24A are made of a strong material such as nylon that will hold the display housing 20 in place against forces such as wind resistance and abrupt braking or turning of the vehicle 10A. An objective of attaching the display housing 20 to be used without modification to the vehicle 10A may also be satisfied using adhesives, suction cups or magnets or other suitable methods (not shown). FIG. 2 shows an alternative method of fastening the display housing 20 to a rooftop of a vehicle using bolts 24B. Attachment with bolts 24B or similar fasteners can be more visually appealing without interfering with window operation and potentially offers a more secure attachment to avoid theft or displacement due to vehicle movement.

FIG. 2 depicts a side elevation cross-sectional view of the display housing 20 of FIG. 1 wherein a motor 27 is used to impart a rotational motion to display surfaces 22A via rotating vertical shaft 28 which is attached to an upper interior portion of the display housing 20. The motor 27 is mounted to a base which is fastened to vehicle 10A with bolts 24B. Motor 27 is connected to a power source (not shown) internal to the vehicle 10A via wires 29. Motor 27 may be powered by a battery of the vehicle 10A or by a separate power supply housed either inside vehicle 10A or interior to the display housing 20 (not shown). Rotational motion may also be created by fastening wind-resistive elements (not shown) to display surfaces 22A so that a motion of the air relative to the vehicle 10A (for example when the vehicle 1OA is moving) will generate a rotational motion about the vertical shaft 28. Thus, this rotational motion may be generated as a product of airflow due to driving the vehicle 10A. Preferably a speed governor is used to limit the rotational motion so that images 30 are easily readable by observers even at high vehicle speeds.

FIG. 3 shows an overhead or top view of display housing 20A having a single display surface 22B in the form of a cylindrical wall rather than the multiple display surfaces 22A of FIG. 1. A direction of (i.e. clockwise) rotational motion is indicated in FIG. 3 by the arrow although either direction of rotation may be used.

Preferably display surfaces 22A (of FIG. 1) and 22B (of FIG. 3) are translucent so that images 30 (see FIG. 1) may be backlit by an illumination source 26 (see FIG. 2) for nighttime viewing.

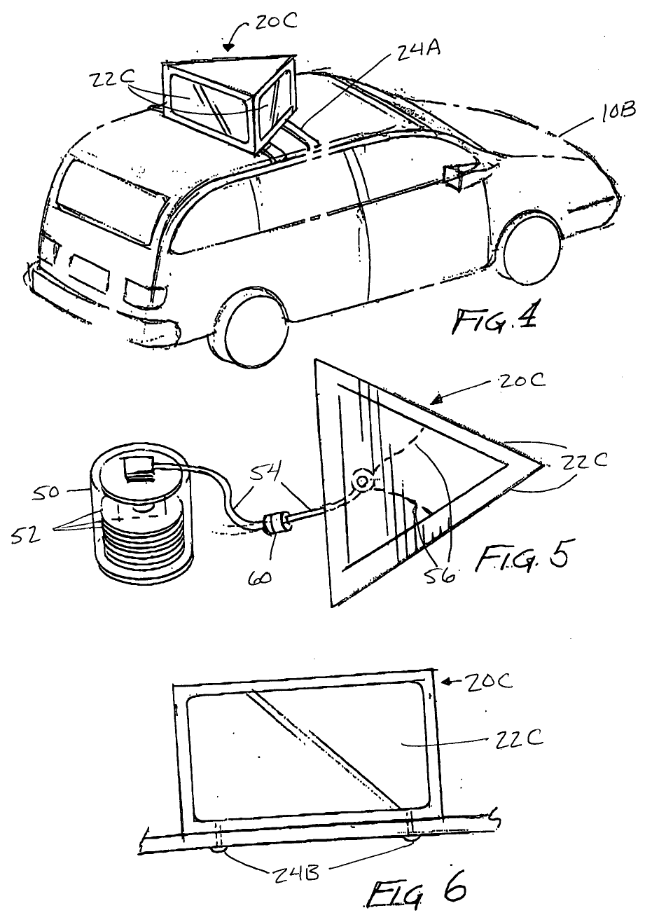

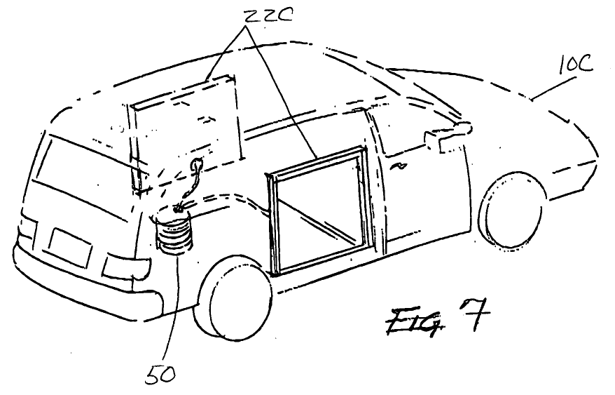

FIGS. 4-6 depicts another embodiment of a vehicle mounted variable display apparatus in accordance with the present invention is shown. A display housing 20C is mounted on a roof of a vehicle 10B. It should be noted that although the display housing in the embodiments shown in FIGS. 1-3 and also FIGS. 4-6 are depicted mounted on the rooftop of a vehicle 10A, 10B, respectively, the display housing may also be mounted on any generally horizontal surface of a vehicle such as a car trunk or a truck bed.

Display screens 22C in FIGS. 4-6 are preferably multi-pixel screens capable of displaying a sequence of images. Preferably, the display screens 22C are television screens. It is further preferred that the display screens 22C are flat-panel plasma screens.

It should be further noted that although FIGS. 4-6 depict a display housing 20C with three display screens 22C, any number of screens may be employed, preferably arranged into regular polygonal shapes so that observers in any direction will see at least one of the display screens 22C. Preferably, display housing 20C is adapted to position and support a variable number of the display screens 22C so that one or more display screens 22C may be added or removed from the display housing 20C and the resulting preferably regular polygonal arrangement of display screens 22C is positioned and supported by the existing display housing 20C. Because an increased number of display screens 22C will increase the size of the display housing 20C and also because each display screen 22C preferably displays a separate sequence of images, from two to eight separate display screens 22C is a preferred practical range for a rooftop-mounted display housing 20C.

Preferably, each display screen 22C receives display information via a video signal cable 56 (see FIG. 5). Display information is preferably provided by a video player 50. Video player 50 preferably features multiple heads for simultaneously reading multiple video storage units 52 such as digital video disks (DVDs) as depicted in FIG. 5. Preferably, the video player 50 can read at least eight video storage units 52 simultaneously and generate at least eight distinct resulting video signals to accommodate each one of the preferred practical range of display screens 22C for the rooftop-mounted display housing 20C. Preferably, the video player 50 can also generate multiple video signals from a single video storage unit 52 to multiple video signal cables 56 for displaying, if desired, an identical sequence of images on multiple display screens 22C. Further preferred is that each video storage unit 52 contains a series of advertisements which may be read sequentially or randomly for display on one or more of the display screens 22C. Still further, it is preferred that the video player 50 be able to direct a video signal generated from reading any one of the video storage units 52 to any one of attached video signal cables 56. It should be noted that although FIG. 5 shows the video signal cables 56 transmitting signals from video player 50 to display screens 22C, wireless transmission of the video (and audio) signal or other transmission means may also be used.

Preferably, the video signal cables 56 are bound into a single bundle 54 for ease of installation and removal. Preferably this bundle 54 uses a wiring connector 60 for quick connection and disconnection of all video signal cables 56. The wiring connector 60 preferably comprises two interlocking pieces, each piece equipped to terminate preferably eight video signal cables 56 in a manner that electrically isolates each of the video signal cables 56 from each other, but allows electrical connection to a corresponding video signal cable 56 terminated in the mating piece of the wiring connector 60. In this manner a single interlocking step will allow or prevent transmission of multiple video signals via video signal cables 56. Preferably the interlocking is accomplished by engaging threaded male and female pieces of wiring connector 60 with a twisting motion, although other suitable methods of interlocking such as clasps may be used.

FIG. 7 depicts another embodiment of the present invention with display screens 22C (which are the same type of display screens as shown in FIGS. 4-6) mounted or connected to generally vertical surfaces of a vehicle 10C and video player 50 within vehicle 10C for generating sequences of images for display on the vertical display screens 22C. Preferably the display screens 22C are substantially flat television screens to allow display of a sequence of images to pedestrian viewers without a hazardous protrusion of the display screens 22C outward from the surface of the vehicle 10C or alternatively consuming a large amount of interior space of the vehicle 10C with conventional television bodies. Preferably, the display panels 22C are easily removable or repositioned, for example, using straps (not shown) over the roof of vehicle 10C or using adhesives, magnetism or suction devices (not shown).

Although FIG. 7 shows one display panel 22C on each side of the vehicle 10C, other arrangements can be made using the present invention, including but not limited to multiple display screens 22C on each side of the vehicle 10C. The display screens 22C may be mounted on any substantially vertical surface of the vehicle 10C such as the back of a van or truck, a tailgate of a pickup truck, a substantially vertical front grille area, or covering a wheel, for example.

While the invention has been particularly shown and described with reference to the preferred embodiments thereof, it will be understood by those skilled in the art that the foregoing and other changes in form, and details may be made therein without departing from the spirit and scope of the invention. For example, it may be desired to use two tiers of display screens on a vehicle rooftop. It may also be desired to use a combination of display screens mounted on both horizontal and vertical surfaces of a vehicle.

1. A vehicle display apparatus comprising, in combination:
a vehicle;
at least one display surface coupled to said vehicle and adapted for displaying at least one sequence of visual images; and
means coupled to said vehicle for generating said at least one sequence of visual images.

2. The vehicle display apparatus of claim 1 further comprising a display housing attached to a generally horizontal surface of said vehicle, said at least one display surface is located on said display housing so that said at least one display surface is visible from all directions by pedestrian viewers.

3. The vehicle display apparatus of claim 1 wherein said at least one display surface is attached to a generally vertical surface of said vehicle so that said at least one display surface is visible by pedestrian viewers.

4. The vehicle display apparatus of claim 2 further comprising means for rotating said display housing about a single vertical axis, said at least one sequence of visual images comprises images for display on said at least one display surface to permit entering and leaving a field of view of a stationary observer as a result of said means for rotating.

5. The vehicle display apparatus of claim 4 wherein said means for rotating comprises a motor.

6. The vehicle display apparatus of claim 1 further comprising an illumination source for illuminating a back surface of said at least one display surface, said at least one display surface is translucent for permitting backlighting said at least one sequence of visual images.

7. The vehicle display apparatus of claim 2 wherein said at least one display surface is an outer surface of a cylindrical wall.

8. The vehicle display apparatus of claim 2 wherein said display housing is adapted for supporting a variable number of said at least one display surface.

9. The vehicle display apparatus of claim 1 wherein each said at least one display surface is a multi-pixel screen.

10. The vehicle display apparatus of claim 9 wherein said means for generating said at least one sequence of visual images comprises:
a video signal generator; and
at least one video storage device coupled to said signal generator so that said at least one video storage device can be read.

11. The vehicle display apparatus of claim 9 wherein said means for generating said at least one sequence of visual images comprises:
a video signal generator; and
a plurality of video storage devices coupled to said signal generator so that said plurality of video storage devices can be simultaneously read.

12. The vehicle display apparatus of claim 10 wherein said means for generating said at least one sequence of visual images further comprising:
a first plurality of wires, each wire having a first end coupled to said video signal generator for transmitting said at least one sequence of visual images;
a second plurality of wires, each wire having a first end coupled to said at least one display surface for transmitting said at least one sequence of visual images; and
a wiring connector coupled to a second end of each of said first plurality of wires and further coupled to a second end of each of said second plurality of wires, wherein connecting said wiring connector couples each one of said first plurality of wires to each corresponding one of said second plurality of wires for transmitting a plurality of electrical signals from said first plurality of wires to said second plurality of wires.

13. A method for displaying at least one sequence of visual images from a vehicle comprising the steps of:
providing a vehicle;
coupling at least one display surface to an exterior surface of said vehicle; and
displaying at least one sequence of visual images on said at least one display surface.

14. The method of claim 13 further comprising rotating said at least one display surface about a vertical axis whereby said at least one sequence of visual images is a result of said rotating, said exterior surface is generally horizontal.

15. The method of claim 14 further comprising backlighting said at least one display surface, said at least one display surface is translucent for enhanced visibility of images thereon.

16. The method of claim 13 wherein each of said at least one display surface is a multi-pixel screen.

17. The method of claim 16, further comprising:
providing a video signal generator adapted to simultaneously read a plurality of video storage devices and generate said at least one sequence of visual images; and
transmitting one of said at least one sequence of visual images to each of said at least one display surface.

18. The method of claim 17 further comprising connecting a wiring connector for coupling said video signal generator to said at least one display surface, said transmitting is performed by wires coupled to said wiring connector.

19. A method of displaying images from a vehicle comprising the steps of:
providing a vehicle having a rooftop;
attaching onto said rooftop a display housing which is adapted to support a variable number of television screens;
mounting a plurality of television screens on said display housing so that from any direction at least one of said television screens is visible by pedestrian observers;
generating a plurality of video signals; and
transmitting each of said plurality of video signals to a corresponding one of said plurality of television screens.

20. The method of claim 19, wherein said generating step is performed by a video signal generator adapted to simultaneously read a plurality of video storage devices,
further comprising connecting a wiring connector for coupling said plurality of television screens to said video signal generator.
